(19) United States
(12) Patent Application Publication
(10) Pub. No.: US 2006/0038864 A1
(43) Pub. Date: Feb. 23, 2006

(54) Inkjet cartridge for inkjet recording apparatus, inkjet recording apparatus and method of supplying ink

(75) Inventors: Takashi Konishi, Sagamihara-shi (JP); Mitsuru Nagasaki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 11/202,826

(22) Filed: Aug. 12, 2005

(30) Foreign Application Priority Data
Aug. 23, 2004 (JP) JP2004-242079

(51) Int. Cl. B41J 2/175

(52) U.S. Cl. 347/86

(57) ABSTRACT

An ink cartridge for inkjet recording apparatus including: an ink pack including an ink feeding section of thermoplastic resin; a bag-like ink accommodation section of multilayer thermoplastic film materials; an ink filled in said ink pack; a positioning control member for controlling a position of said ink feeding section; and an outer box for accommodating said ink pack, wherein said ink feeding section comprises a hollow cylindrical ink feeding tube including: a joint section for jointing with said ink accommodation section; a positioning control means accommodated in said positioning control member; a first opening through which an ink supply means in said inkjet recording apparatus can be inserted and pulled out; a second opening for supplying said ink to said inkjet recording apparatus from said ink accommodation section via said first opening; and a cover for opening said second opening by inserting said ink supply means and for closing said second opening by pulling out said ink supply means, and wherein said ink is the UV curing type with a viscosity of 0.005 through 0.1 Pa·s.

This application is based on Japanese Patent Application No. 2004-242079 filed on Aug. 23, 2004, in Japanese Patent Office, the entire content of which is hereby incorporated by reference.

### TECHNICAL FIELD

The present invention relates to an inkjet cartridge for inkjet recording apparatus (also referred to merely as an ink cartridge hereinafter), an inkjet recording apparatus,

### BACKGROUND

In recent years, the inkjet recording system, which makes it possible to create images simply and inexpensively, has been applied to a wide range of printing areas such as photographs, various types of printings, markings, and color filters. Particularly, a picture quality equivalent to that of the conventional photography can be obtained in combination with a recording apparatus which emits and controls fine dots, an ink in which color reproduction range, durability, emission capability and the like are improved, and an exclusive paper in which ink absorbency, coloring development, surface gloss and the like are substantially improved. Today's improvement of picture quality in the inkjet recording system has been achieved only when the recording apparatus, the ink, and the exclusive paper have been all provided.

However, the inkjet system that requires the exclusive paper is disadvantageous in that usable recording media are limited and the cost of the recording media is increased. In order to cope with the above problem, a number of efforts are made to record on media to be transferred which are different from the exclusive paper by the inkjet system. More specifically, there are the phase change inkjet system using a wax ink which is solid at room temperature, the solvent based inkjet system using an ink which is mainly made of a quick-drying organic solvent, and the activated light curing inkjet system which causes components to bridge with ultraviolet rays (UV) or electron beams after recording.

Among them, the UV inkjet system has recently been attracting attention to the point that the UV inkjet system is relatively low off-flavor compared to the solvent based inkjet system and is able to record on recording media without characteristics of quick-drying and ink absorbency, and for example, UV curing inkjet inks are disclosed in Japanese Patent Publication Laid-Open No. HEI 6-200204, Publication of a Translation of an International Application No. 2000-504778, International Application Published Under the Patent Corporation Treaty (PCT) Nos. 99/29787, 99/29788, 97/31071, Japanese Patent Publication Laid-Open No. HEI 5-214280, and Japanese Patent Publication Laid-Open No. 2002-188025. However, there is known that the UV curing ink has a higher viscosity as compared to that of typical water-based inks and it is extremely difficult to carry out a constant and accurate emission of very small liquid droplets.

The inkjet recording apparatus emits ink droplets from an inkjet head which is a fine nozzle of 10 to 100 μm to draw characters or images on a recording paper, so that the ink is required to constantly flow through the fine nozzle and narrower flow paths.

As the supply of ink to the inkjet head of the inkjet recording apparatus, for example, Japanese Patent Publication Laid-Open Nos. 2001-232812, 2002-331679, 2003-145785, 2003-226023 disclose ink cartridges which accommodate an ink pack having an ink accommodation section of a thermoplastic film and an ink feeding section in an outer box, which are used because of the usability.

Further, in accordance with the recent remarkable developments of digital equipment, inkjet printers for visualizing the information of such digital equipment are increasingly-desired to reproduce sophistication. An enlargement of the size is also desired. Particularly, the types of inks used for the inkjet recording apparatus that creates large size images are required to faithfully perform color reproduction, so that dark and light inks for each of the red, yellow, blue, and black colors, namely the total of 8 colors are prepared.

Since creating a large size image requires a lot of time, usually the creation is made with no operator present during the night hours. In this case, in order to avoid running out of ink during the creation, the ink cartridge is replaced with a new one. The ink cartridge having been removed during the operation is used for creating other images when the operator is present.

Accordingly, because the ink replacement is also frequently carried out, making cartridges easily replaceable has been considered. For example, there is known a cartridge in which, when used, a hollow needle for supply in an inkjet recording apparatus side is inserted into an ink feeding section plugged with an elastic member of the ink cartridge to supply an ink to an inkjet head via the hollow needle, and after finished the ink supply, the ink feeding section is closed again by pulling out the hollow needle to store the ink (for example, see Patent Documents 1 and 2).

However, in the case of the ink cartridge described in Patent Documents 1 and 2, as the ink is supplied to the inkjet head by inserting the hollow needle into the elastic member of the ink feeding section, the needle must be thickened in order to obtain a constant amount of ink. Meanwhile, when the needle is thickened, sealing capability may be degraded when pulling out the needle. Particularly in the case of the UV curing ink with a high viscosity, the needle must be thickened in order to keep the flow volume, causing leakage of the ink when putting in and taking out the ink cartridge, and the remaining ink after use may be deteriorated in quality due to evaporation of solvent and the like, so that the remaining ink is discarded or used by designing to make the used residue as small as possible.

There is known a cartridge in which, when used, a plug is opened by inserting a hollow bar-like member for supply in an inkjet recording apparatus side into an ink feeding section plugged via an energizing member of the ink cartridge, and after finished the ink supply, the ink feeding section is closed again with the plug via the energizing member to store the ink (for example, see Patent Document 3).

However, in the case of the ink cartridge described in Patent Document 3, the energizing member (e.g. a spring) and the plug are required in the ink feeding section, so that the number of parts composing the ink cartridge increases and the amount of work required for assembly of the ink feeding section grows, thereby the cost may rise. Further, when using a metal spring for the energizing member, the need for separation occurs in the waste disposal after use, which disadvantageously lacks environmental adequacy.

With these circumferences, it is desired to develop an ink cartridge which is easily replaced toward the inkjet recording apparatus, capable of being reused by preventing deterioration of an ink in the ink cartridge after use, and enabling the constant supply of a required amount of ink to the inkjet head even using the ink having a high viscosity; an inkjet recording apparatus having an ink supply means; and a method of supplying ink to the inkjet recording apparatus.

[Patent Document 1] Japanese Patent Publication Laid-Open No. 2002-347257

[Patent Document 2] Japanese Patent Publication No. 2936682

[Patent Document 3] Japanese Patent Publication No. 3016740

The present invention is made in light of the circumstances as described above, and its object is to provide an ink cartridge which is easily replaced toward the inkjet recording apparatus, capable of being reused by preventing deterioration of an ink in the ink cartridge after use, and enabling the constant supply of a required amount of ink to an inkjet head even using the ink having a high viscosity; an inkjet recording apparatus having an ink supply means; and a method of supplying ink to the inkjet recording apparatus.

### SUMMARY

An aspect of the present invention is as follows:

An ink cartridge for inkjet recording apparatus which accommodates an ink pack in an outer box, the ink pack having an ink feeding section made of thermoplastic resin and a bag-like ink accommodation section made of multilayer thermoplastic film materials and being filled with an ink, in the state in which a position of the ink feeding section is controlled by a positioning control member, wherein the ink feeding section has a hollow cylindrical ink feeding tube having a joint section for jointing the ink accommodation section and a positioning control means; the positioning control means being accommodated in the positioning control member; the ink feeding tube having a first opening provided in the inkjet recording apparatus side which enables insertion and pull-out of an ink supply means of the inkjet recording apparatus, a second opening provided inside the ink accommodation section which supplies the ink to the inkjet recording apparatus, and a cover which opens the second opening by inserting the ink supply means and closes the second opening by pulling out the ink supply means; the ink being the UV curing type with a viscosity of 0.005 through 0.1 Pa·s.

Another aspect of the present invention is as follows:

An inkjet recording apparatus having an ink supply means which receives the supply of ink by being inserted into an ink feeding section, using an ink cartridge for inkjet recording apparatus accommodating an ink pack in an outer box; the ink pack including the ink feeding section made of thermoplastic resin and a bag-like ink accommodation section made of multilayer thermoplastic film materials and being filled with an ink, wherein the ink feeding section has an ink feeding tube including a joint section for jointing the ink accommodation section and a positioning control means; the positioning control means being accommodated in the positioning control member; the ink feeding tube having a first opening in a loading section side of the inkjet recording apparatus and a second opening in the ink accommodation section side; the second opening having an open-closeable cover including an engagement section for engaging with the ink feeding tube; the ink supply means having an insertion member which can be inserted and pulled out through the first opening; the insertion member having a hollow cylindrical ink supply tube including in an end portion thereof an engagement section for opening and closing the cover, at least one ink supply port, and an ink leakage prevention member; the ink being the UV curing type with a viscosity of 0.005 through 0.1 Pa·s; an area of the ink supply port being 1 through 20 mm²; and an inner diameter of the ink feeding tube being 4 through 8 mm.

Still another aspect of the present invention is as follows:

A method of supplying ink to an inkjet recording apparatus having an ink supply means which receives the ink supply at an inkjet head by being inserted into an ink feeding section, using an ink cartridge for inkjet recording apparatus accommodating an ink pack in an outer box, the ink pack including the ink feeding section made of thermoplastic resin and a bag-like ink accommodation section made of multilayer thermoplastic film materials and being filled with an ink in the state in which a position of the feeding section is controlled by a positioning control member, wherein the ink feeding section having an ink feeding tube including a joint section for jointing the ink accommodation section and a positioning control means; the positioning control means being accommodated in the positioning control member; the ink feeding tube having a first opening in a loading section side of the inkjet recording apparatus and a second opening in the ink accommodation section side; the second opening having an open-closeable cover having an engagement section for engaging with the ink feeding tube; the ink supply means having an insertion member capable of being inserted and pulled out through the first opening; the insertion member having a hollow cylindrical ink supply tube including in an end portion thereof an engagement section for opening and closing the cover, at least one ink supply port, and an ink leakage prevention member; the ink being the UV curing type with a viscosity of 0.005 through 0.1 Pa·s; an area of the ink supply port being 1 through 20 mm²; an inner diameter of ink the supply tube being 4 through 8 mm.

### BRIEF DESCRIPTION OF THE DRAWINGS

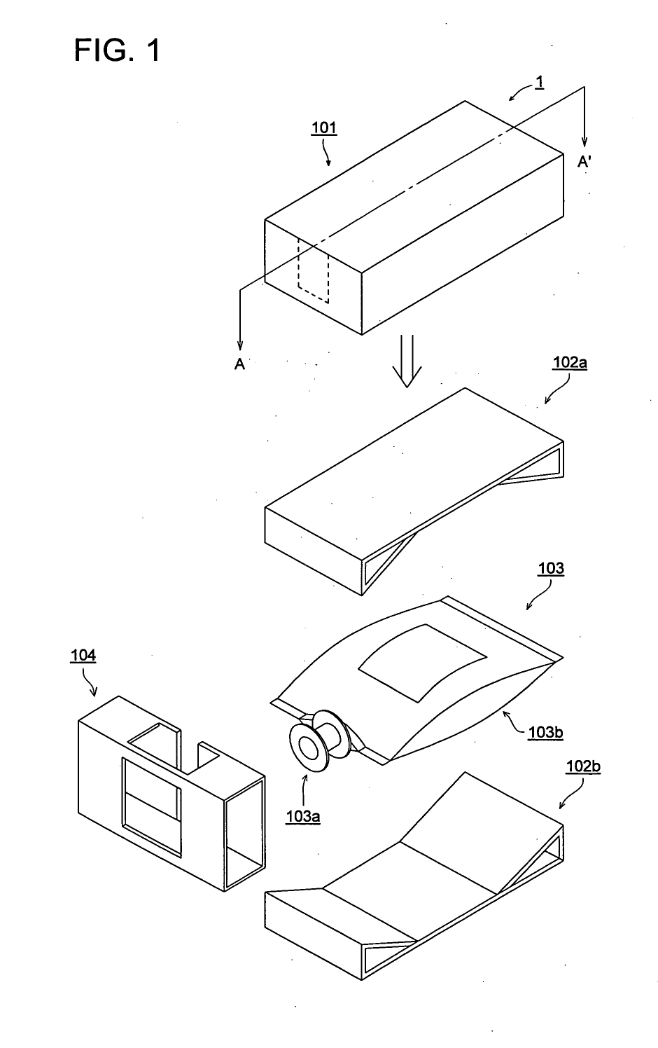

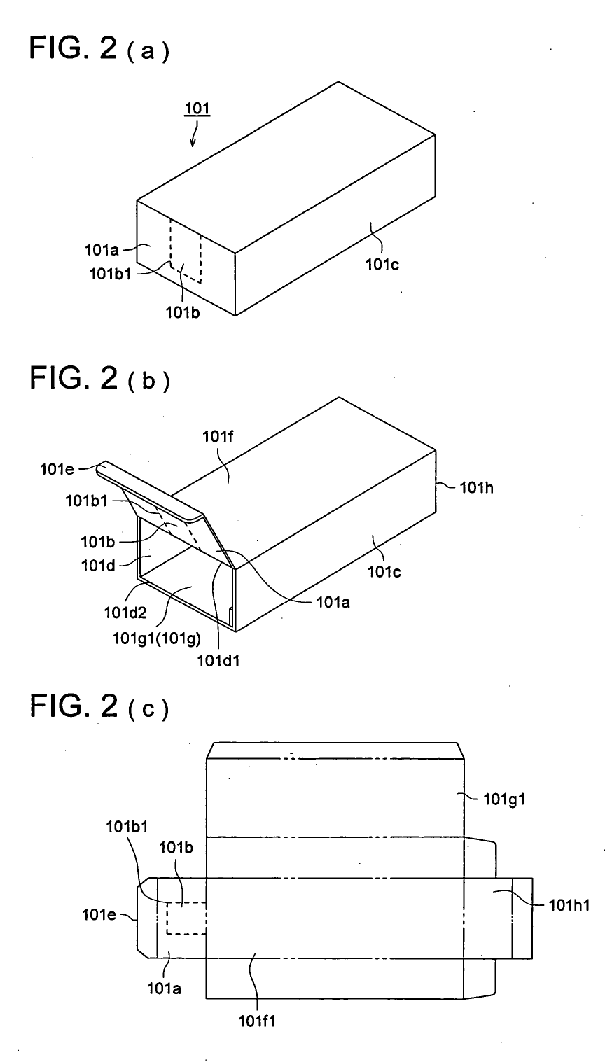

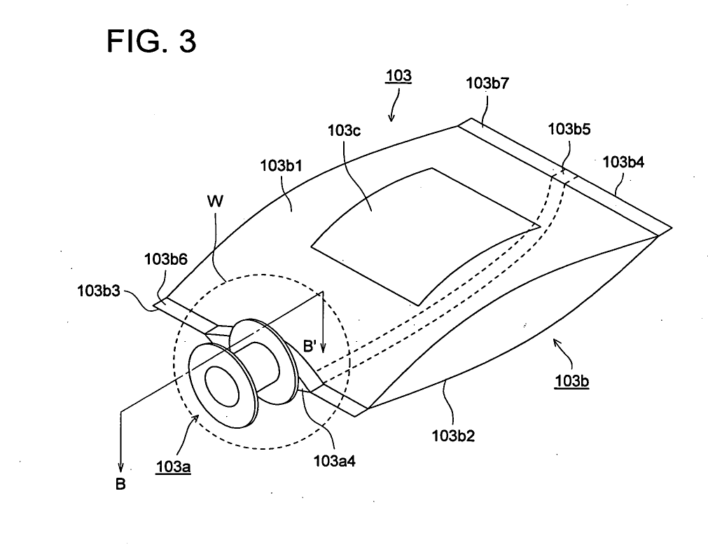

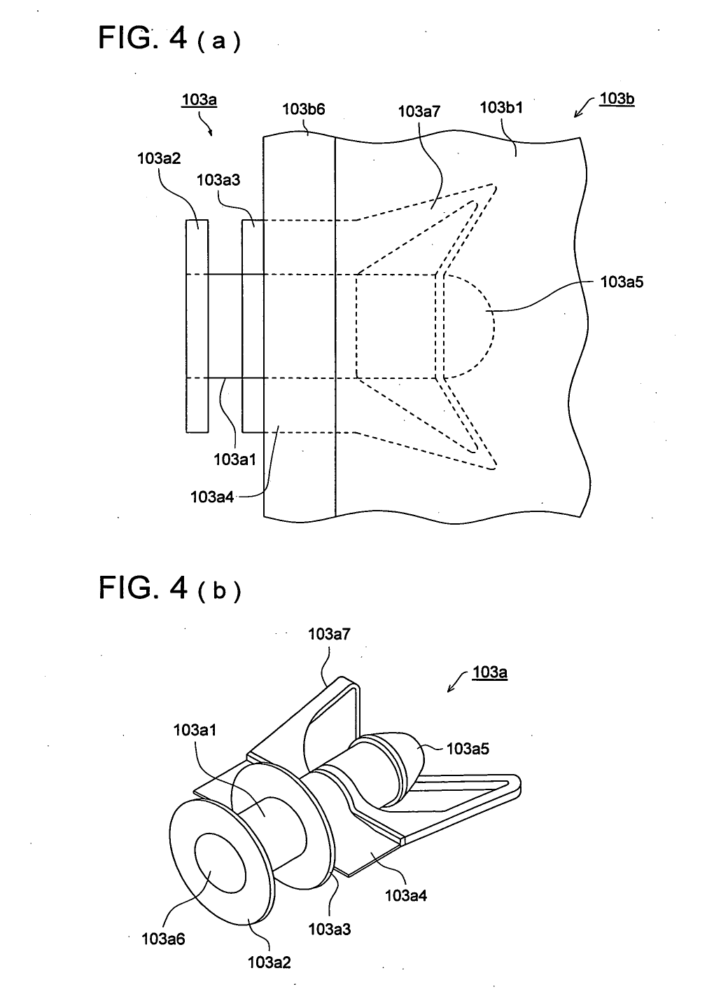

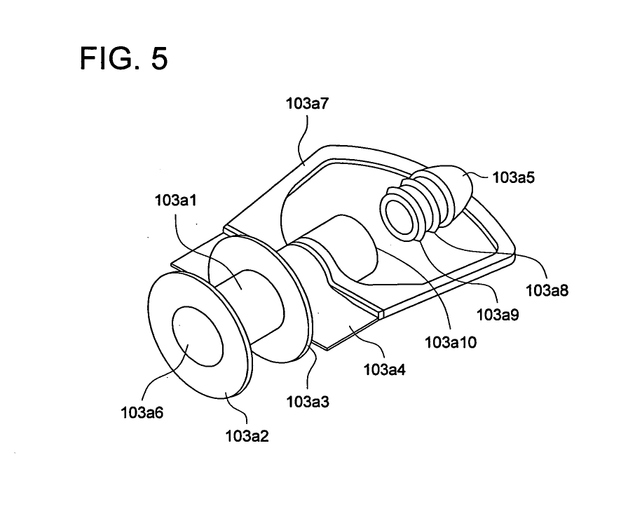

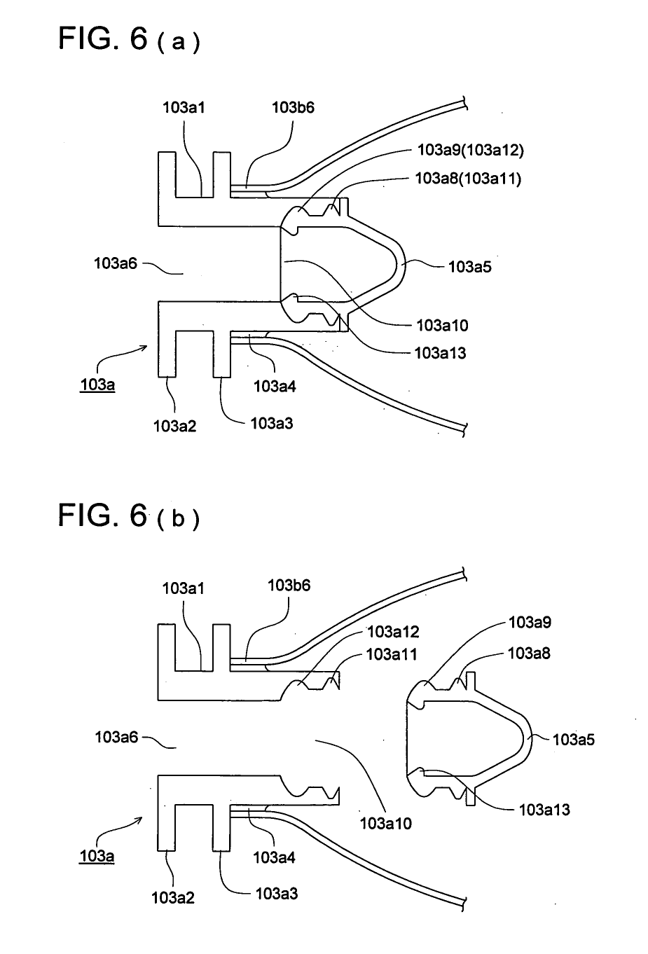

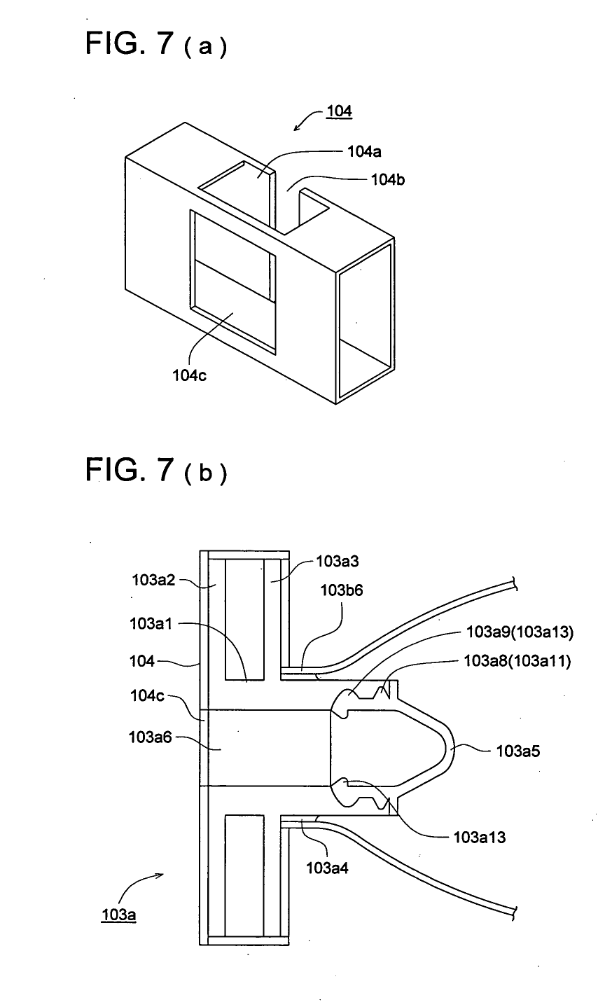

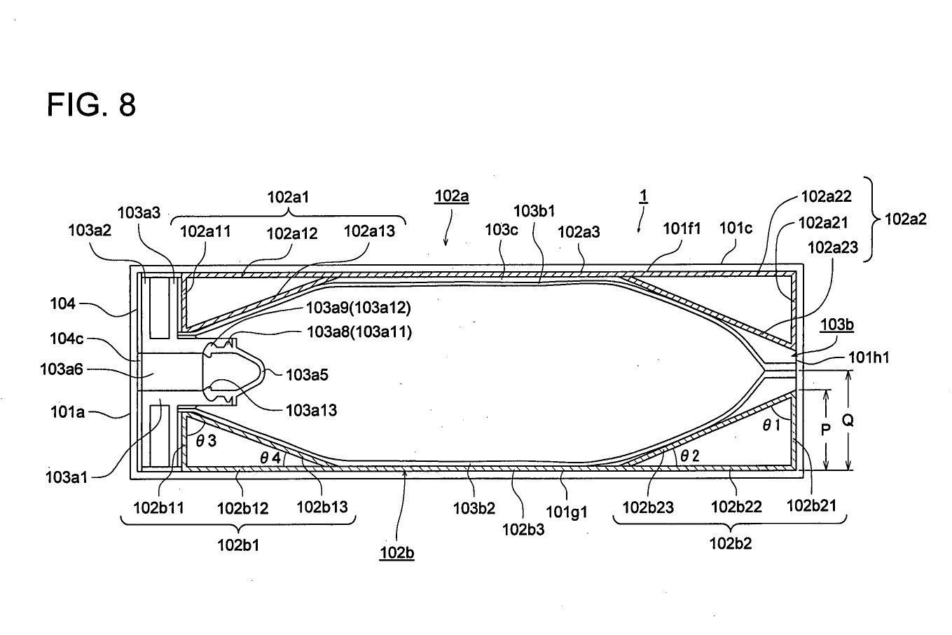

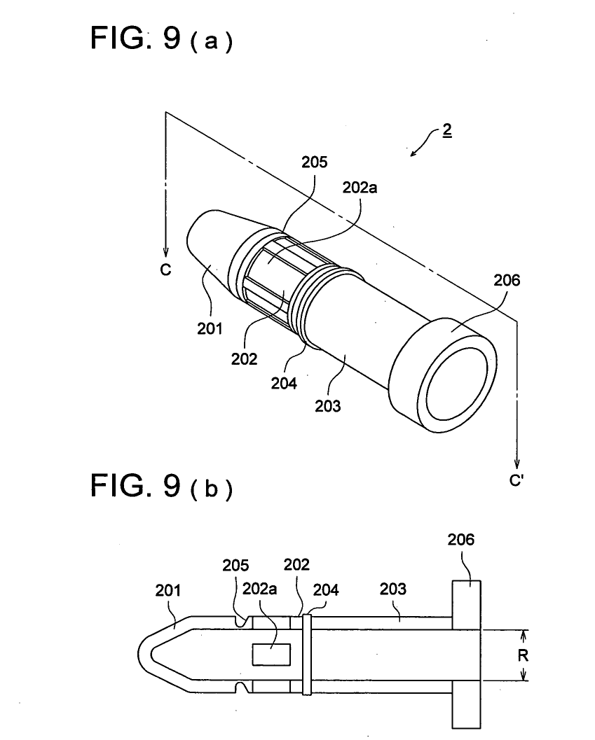

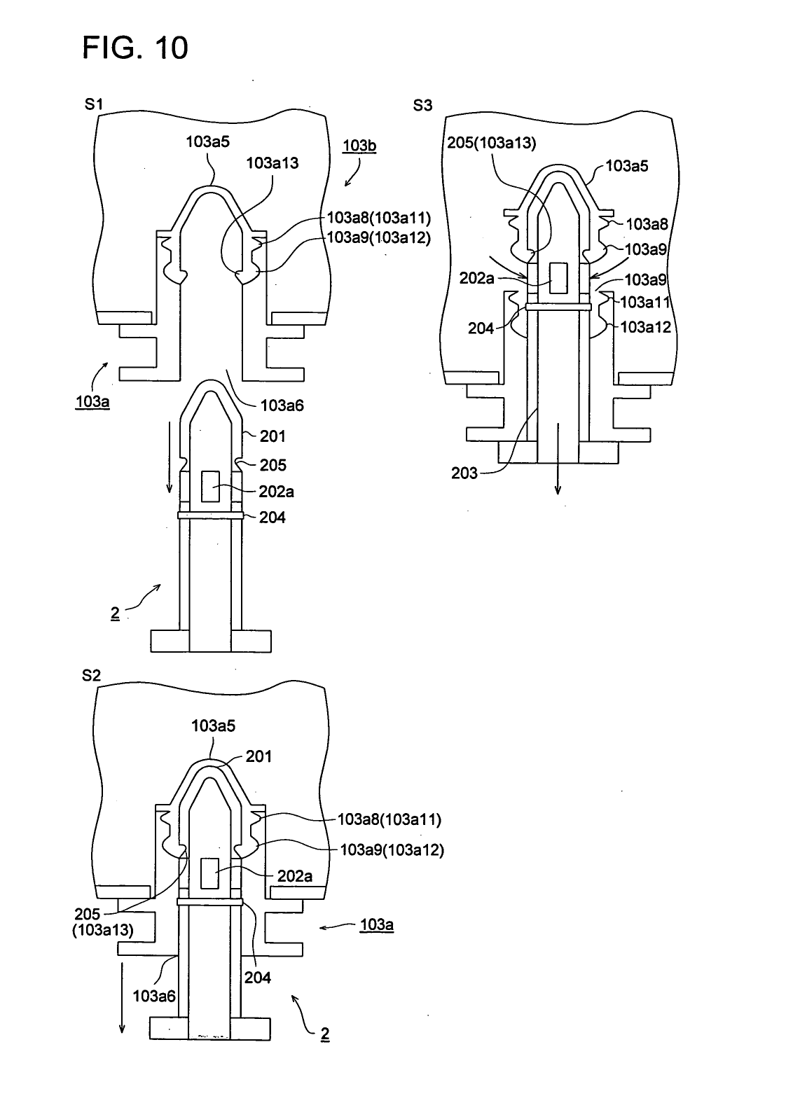

Embodiments will now be described, by way of example only, with reference to the accompanying drawings which are meant to be exemplary, not limiting, and wherein like elements numbered alike in several Figures, in which:

[FIG. 1] A general exploded perspective view of an ink cartridge;

[FIG. 2] A general view of an outer box shown in FIG. 1;

[FIG. 3] An enlarged general view of an ink pack shown in FIG. 1;

[FIG. 4] An enlarged general view of a portion indicated by W of FIG. 3;

[FIG. 5] A general perspective view showing the state where a cover of an ink feeding section shown in FIG. 4 is opened;

[FIG. 6] A general cross-sectional view taken along the line B-B′ of FIG. 3;

[FIG. 7] An enlarged general view of a positioning control member shown in FIG. 1;

[FIG. 8] An enlarged general cross-sectional view taken along the line A-A′ of the ink cartridge shown in FIG. 1;

[FIG. 9] A general view of an ink supply tube which is an ink supply means in the inkjet recording apparatus side; and

[FIG. 10] A general flow chart of the ink supply from the ink pack to an inkjet through the ink supply tube which is the ink supply means in the inkjet recording apparatus side.

### DESCRIPTION OF THE PREFERRED EMBODIMENTS

The embodiments according to the present invention will be described with reference to FIGS. 1 through 10. However, the present invention is not to be construed as limited these embodiments.

FIG. 1 is a general exploded perspective view of an ink cartridge.

In this figure, reference numeral 1 denotes an ink cartridge. The ink cartridge 1 has an outer box 101; an ink pack 103 including an ink feeding section 103a and an ink accommodation section 103b; a positioning control member 104 for determining a position of the ink feeding section 103a; a first protective member 102a and a second protective member 102b for protecting the ink accommodation section 103b of the ink pack 103 in the state where being held therebetween. Each of the members composing the ink cartridge shown in the figure will be sequentially described with reference to FIGS. 2 through 10 below.

FIG. 2 is a general view of the outer box shown in FIG. 1. Fig. 2(a) is a general perspective view of the outer box. FIG. 2(b) is a general perspective view of the outer box in the state where an opening is opened. FIG. 2(c) is a general exploded view of the outer box. Incidentally, the exploded view is in the state seen from inside.

The outer box 101 has a main body 101c having a rectangular opening 101d; an open-close cover 101a provided via a folding line in the opening 101d. Reference numeral 101b denotes a cut-off section provided in the open-close cover 101a. Reference numeral 101b1 denotes a perforated line for cutting off the cut-off section 101b from the open-close cover 101a. Reference numeral 101e denotes a flap provided in the open-close cover 101a which can be fixed in the main body 101c by the flap 101e. The fixing method of the open-close cover 101a in the main body 101c may be that by an adhesive tape, in addition to the method by the flap 101e. The opening 101d can be mounted with a positioning control member 104 (see FIG. 1).

Reference numeral 101f1 denotes a first face inside a face 101f containing a long side 101d1 of the opening 101d. Reference numeral 101h1 denotes a second face inside a face 101g containing a long side 101d2 of the opening 101d. Reference numeral 101h1 denotes a face inside an opposed face 101h of the main body 101c opposite to the opening 101d. The outer box 101 can be assembled by folding each of the sides along folding lines in accordance with the exploded view shown in FIG. 2(c), followed by fixing the flap.

The type of the outer box is not specifically limited and may be, for example, that described in JISZ1507, or that described in “Saishin Kamikako Binran (Current Paper Manufacturing Handbook) by Tech Times K.K., pages 821-824. The outer box in this figure shows the case being produced with a one-piece material.

As the material used for the outer box 101c, any material may be used as long as it is generally used for boxes, including paper materials such as paperboards and cardboards, thermoplastic resins, however, in the view of reducing the environmental burden, a paper product is preferred. As the paper material, there may be used a white paperboard or a cardboard which are the typical board papers described in “Saishin Kamikako Binran (Current Paper Manufacturing Handbook)” by Tech Times K.K. The paperboard preferably has a basis weight of 300 through 700 g/m², more preferably 400 through 600 g/m². When the basis weight is less than 300 g/m², it may be difficult to maintain the strength for handling and transportation. When the basis weight is more than 700 g/m², the workability in producing the outer box may be degraded, or the environmental burden may increase due to over quality. The thickness is preferably 260 through 1140 μm, more preferably 480 through 920 μm, and when less than 260 μm, it may be difficult to maintain the strength for handling and transportation. When the thickness is more than 1140 μm, the environmental burden may increase due to over packaging.

As the cardboard, there may be preferably used the typical A flute through E flute of double faced cardboard and double wall corrugated fiberboard as described in “Saishin Kamikako Binran (Current Paper Manufacturing Handbook)” by Tech Times K.K., however, there is no specific limitation. It may be suitably selected depending on the size of the ink container.

The surface of the ink cartridge of the present invention is displayed with an indication for identifying the ink therein, and the indication method may be provided by directly printing on the surface of the cartridge, or by affixing a label with an identification indication.

FIG. 3 is an enlarged general perspective view of the ink pack shown in FIG. 1.

In the figure, reference numeral 103b1 denotes an a-face (the upper side face in the figure) of the thermoplastic film forming the ink accommodation section 103b, in which the a-face 103b1 is a face containing short sides 103b3 (103b4) of the ink accommodation section 103b. Reference numeral 103b2 denotes a b-face (the opposite face of the upper side face in the figure) of the thermoplastic film forming the ink accommodation section 103b, in which the b-face is a face containing the short sides 103b3 (103b4) of the ink accommodation section 103b and, being opposite to the a-face 103b1.

Reference numeral 103b5 denotes a center seal portion for making the bag-like ink accommodation section 103b, while reference numeral 103b7 denotes the other seal portion for making the bag-like form. The form of the ink accommodation section 103b is not specifically limited, and for example, the bag-like form may be formed by sealing three sides of two thermoplastic films, or by folding one thermoplastic film followed by sealing two sides. The figure shows the case of making a bag-like form by folding one thermoplastic film followed by sealing two sides, which is so-called the center seal system in which the seal position is at the center. Reference numeral 103b6 denotes a seal portion in which the ink accommodation section 103b is jointed to a joint member 103a4 of the ink feeding section 103a. The method for jointing the ink accommodation section 103b to the joint member 103a4 may be provided by inserting the joint member 103a4 into the ink accommodation section 103b followed by sealing and applying with thermal welding or an adhesive and the like. Reference numeral 103c denotes, when the ink pack 103 is accommodated in the outer box 101 (see FIG. 1), a double-stick tape for fixing either of the a-face 103b1 or b-face 103b2 of the ink accommodation section 103b in the inside of the outer box. The figure shows the case in which the double-stick tape 103c is applied to the a-face 103b1 of the ink accommodation section 103b. As the means for fixing either of the a-face 103b1 or b-face 103b2 of the ink accommodation section 103b to the inside of the outer box, the adhesive may be used. The ink feeding section 103a will be described in detail with reference to FIG. 3.

The method of making the ink pack 103 shown in the figure may be provided by at first making a cylindrical ink accommodation section using a multilayer thermoplastic film, mounting an ink feeding section in either of the openings, filling ink from the other opening under reduced pressure, followed by sealing with thermal welding or an adhesive. As the method of making the cylindrical ink accommodation section, there may be considered, for example: 1) a method of applying the long sides of the two rectangular multilayer thermoplastic films with thermal welding or an adhesive; 2) a method of folding one rectangular multilayer thermoplastic film in half from the longitudinal center followed by applying both of the long sides with thermal welding or an adhesive; and 3) a method of folding one rectangular multilayer thermoplastic film in half from the lateral center followed by applying the long sides with thermal welding or an adhesive, and the ink accommodation section can be made by suitably selecting a method that would be the easiest to make.

The method of mounting the ink feeding section in the body is provided by inserting the joint member which is mounted in the ink feeding tube of the ink feeding section into the ink accommodation section, followed by applying with thermal welding or an adhesive to make the ink pack. Incidentally, it is assumed that a side in which the ink accommodation section 103 is mounted with the ink feeding section 103a is the front portion and the opposite side is the rear portion.

Although the material used for the ink feeding section 103a is not specifically limited, the thermoplastic resin is the most preferred from the standpoint of the cost and the easiness of production. The production method may be provided by the injection molding method which is commonly used as described in “Jitsuyou plastic Seikei Kakou Binran (Practical Plastic Molding Handbook)” edited by All Japan Plastic Products Industrial Federation. Although the thermoplastic resin to be used herein is not specifically limited as long as injection molding is possible, there may be used common resins such as, for example, polyethylene, polystyrene, polyamide, polyacetal, polycarbonate, and polypropylene.

As the thermoplastic film used for the ink accommodation section, the multilayer thermoplastic film is preferred. The rigidity of the multilayer thermoplastic film used in the present invention is, when considering 1) the oxygen transmission rate, 2) the joint strength with the ink feeding section, 3) usability, 4) the amount of ink residue and the like, preferably in the range of 7.9×10⁻⁷ through 1.9×10⁻⁶ Nm², more preferably 6.7×10⁻⁷ through 3.1×10⁻⁶ Nm². The rigidity is the value measured using the tension tester PSC-100 manufactured by Shimazu Corporation.

The thickness of the multilayer thermoplastic film used in the present invention is associated with the rigidity as described above, keeping the preferred range of the rigidity, and when considering 1) the strength as the ink accommodation section, 2) usability, 3) environmental burden, 4) the amount of ink residue and the like, being preferably in the range of 73 through 150 μm, more preferably 83 through 130 μm.

For the multilayer-thermoplastic film of the present invention, inorganic evaporated films or aluminum evaporated films may be used. As the inorganic evaporated films, there may be mentioned inorganic films described in “Usumaku Handbook (Thin Film Handbook)” pages 879-901 (Japan Society for the Promotion of Science), “Shinku Gijutsu Handbook (Vacuum Technology Handbook)” pages 502-509, 612, 810 (The Nikkan Kogyo Shinbun), “Shinku Handbook Zoteiban (Vacuum Handbook Enlarged and Revised Edition)” pages 132-134 (ULVAC Japan Ltd.). For example, Cr₂O₃, Ta₂O₃ ZrN, SiC, TiC, PSG, Si₃N₄, single crystal Si, amorphous Si, W, AI₂O₃ and the like are used. Among them, the most preferred inorganic evaporated film may be alumina (AI₂O₃) from the standpoint of the strength and transparency of the evaporated film. As the method of making the inorganic evaporated film, there may be mentioned common methods as described in “Shinku Gijutsu Handbook oyobi Hoso Gijutsu (Vacuum Technology Handbook and Packaging Technology) Vol. 29, No. 8, for example, the resistance or high-frequency wave induction heating method, electro-beam (EB) method, plasma (PCVD) and the like. The thickness of the evaporated film is preferably in the range of 40 though 200 nm, more preferably 50 through 180 nm.

As the thermoplastic resin film used as the base material of the present invention, there may be mentioned film materials used for general packaging films, such as ethylene-tetrafluoroethyl copolymer (ETFE), high-density polyethylene (HDPE), biaxially oriented polypropylene (OPP), polystyrene (PS), polymethyl methacrylate (PMMA), biaxially oriented nylon 6 (ONy), polyethylene terephthalate (PET), polycarbonate (PC), polyimide, and polyether styrene (PES).

As the thermoplastic resin film used through the evaporated film sheet, there may be mentioned low-density polyethylene (LDPE), high-density polyethylene (HDPE), linear low-density polyethylene (LLDPE), medium-density polyethylene, non-oriented polypropylene (CPP), biaxially oriented polypropylene (OPP), biaxially oriented nylon (ONy), polyester (PET), cellophane, polyvinyl alcohol (PVA), biaxially oriented vinylon (OV), ethylene-vinyl acetate copolymer (EVOH), vinylidene chloride (PVDC) and the like, which are polymeric films used as general packaging materials (for example, those described by Toray Research Center Inc., the new development corporation of functional packaging materials).

Also as the thermoplastic films, there may be naturally used, according to the necessity, a multilayer film formed by coextrusion with foreign films or a multilayer film formed by laminating with the stretching angle varied. Further, in order to obtain the physical characteristics of the required packing materials, it is naturally possible to form in combination with the densities and molecular weight distributions of the films to be used. For the thermoplastic film in the most inner layer, there are used low-density polyethylene (LDPE), low-density polyethylene (LDPE) produced using linear low-density polyethylene (LLDPE) and metallocene catalyst, linear low-density polyethylene (LLDPE), or a film using a mixture of these films and a high-density polyethylene (HDPE) film. Particularly, among them, from the standpoint of the melting temperature and the strength, LLDPE produced using a metallocene catalyst is preferred and commercially available products may adequately be used. For example, there may be mentioned UMERIT manufactured by Ube Industries Ltd., AFFINITY, ELITE manufactured by Daw Chemical Co., Ltd., HARMOREX LL manufactured by Japan Polyolefin Co., Ltd., CARNEL 57L manufactured by Japan Plychem Co., Ltd., EVOLU manufactured by Mitsui Chemical Inc, LAMILON SUPER manufactured by Sekisui Chemical Co., Ltd., SE SERIES manufactured by Tama Poli Co., Ltd., TOHCELLO T.U.X-FCS, T.U.X-TCS manufactured by Tohcello Co., Ltd., TAIKO FL manufactured by Futamura Chemical Co., Ltd., METALLO ACE manufactured by Mitsubishi Chemical Kohjin PAX Co., Ltd., WMX manufactured by Wada Chemical Industries Co., Ltd., FV202 manufactured by Sumitomo Chemical Co., Ltd., and the like.

When not using the inorganic evaporated layer, there may be used a single film or two or more films laminated by suitably selecting among the thermoplastic films described above according to the necessity. For example, CPP/OPP, PET/OPP/LDPE, Ny/OPP/LDPE, CPP/OPP/EVOH, saran UB/LLDPE (wherein saran UB represents a biaxially oriented film made from vinylidene chloride ethyl/acrylate ester based copolymer resin manufactured by Asahi Kasei Corporation), K-OP/PP, K-PET/LLDPE, K-Ny/EVA (wherein K represents a film coated with vinylidene chloride resin), and the like.

As the production method of the laminated film described above, there may be used various types of known methods as described in CONBERTECH May, 1990, pages 40-48, for example, such as wet lamination, dry lamination, hot melt lamination, extrusion lamination, thermal lamination. The film may also be produced by the multilayer inflation method depending on the materials to be used.

As the adhesive to be used in the lamination, there may be used known adhesives as described in CONVERTECH January, 1996, pages 18-22; October, 1997, pages 13-17 and 21-25.

Incidentally, when the ink to be accommodated in the ink accommodation section is the UV curing type, a film containing carbon is preferably combined with an aluminum evaporated film or an aluminum foil laminated film to form a multilayer film.

The UV curing type ink to be used in the present invention is not specifically limited as long as having a viscosity of 0.005 through 0.1 Pa·s, and for example, there may be mentioned the UV curing type inks having the compositions as described in Japanese Patent Publication Laid-Open No. HEI 10-324836, Japanese Patent Publication Laid-Open Nos. 2002-167537, 2002-179967, 2002-241654, 2003-147233, 2004-18716, 2004-59810, 2004-59857, 2004-124077, 2004-131589, 2004-131725, 2004-182933.

When the viscosity is less than 0.005 Pa·s, it is difficult to constantly emit the ink in the state of droplets from the inkjet head, resulting in the high-speed capability being insufficient and the productivity being reduced, which is not preferred. When the viscosity is more than 0.1 Pa·s, the viscosity is so high that the constant ink supply from the ink feeding tube to the inkjet head is difficult, which is not preferred. The viscosity measurement shows the value measured at 25° C. using the Reometer MCR 300 manufactured by Physica Co., Ltd.

FIG. 4 is an enlarged general view of a portion indicated by W of FIG. 3. FIG. 4(a) is an enlarged general plane view of the portion indicated by W of FIG. 3. FIG. 4(b) is an enlarged general perspective view of the ink feeding section shown in FIG. 3.

In the figure, reference numeral 103a denotes an ink feeding section. The ink feeding section 103a has an ink feeding tube 103a1, two flange members 103a2 (103a3) of the positioning control means mounted in the ink feeding tube 103a1, a joint member 103a4 mounted in the ink feeding tube 103a1 and jointing to the ink accommodation section, and a cover 103a5 enabling a second opening 103a9 (see FIG. 5) in the ink accommodation section side to open and close. The cover 103a5 is preferably mounted in the ink feeding tube 103a1 via a drop prevention member 103a7. Reference numeral 103a6 denotes a first opening for inserting an ink supply means (not shown) in the inkjet recording apparatus side of the inkjet feeding tube 103a1.

The spacing between the two flange members 103a2 (103a3) may be suitably determined depending on the width of the accommodation section 104a (see FIG. 7) of the positioning control member 104 (see FIG. 7), and the ink feeding section 103a may be fixed and positioned by accommodating the flange members 103a2 (103a3) in the accommodation section 104a (see FIG. 7).

The thickness of the joint member 103a4 is preferably 0.2 through 2 mm, more preferably 0.3 through 1 mm, considering 1) the mounting strength with the ink feeding tube; 2) the production process, the usability in transportation; and 3) the amount of ink residue and the like.

The diameter of the ink feeding tube 103a1, which is associated with the thickness of the ink supply means in the inkjet recording apparatus side and the thickness of the joint member 103a4, must be suitably determined according to these thicknesses. Further, in order to securely joint the ink accommodation section 103b by the joint member 103a4, concave grooves are preferably provided in a top face and a bottom face of the joint member 103a4, so that also the diameter of the ink feeding tube 103al must be suitably determined according to the thickness by which the grooves can be provided.

FIG. 5 is a general perspective view showing the state in which the cover of the ink feeding section shown in FIG. 4 is opened. Incidentally, the ink supply means in the inkjet recording apparatus side which is inserted from the first opening 103a6 for opening the cover is omitted herefrom.

In the figure, reference numeral 103a8 denotes a first engagement rib and reference numeral 103a9 denotes a second engagement rib. When the cover 103a5 engages with an engagement rib (not shown) provided inside the ink feeding tube 103a1 by the first engagement rib 103a8 and the second engagement rib 103a9, the cover 103a5 closes the second opening 103a10 before use, being capable of preventing the leakage of the ink filled in the ink accommodation section. The cover 103a5 is released from the engagement with the first engagement rib 103a8 and the second engagement rib 103a9 due to the pressure of the ink supply means in the inkjet recording apparatus side which is inserted from the first opening 103a8 to open the second opening 103a10.

FIG. 6 is a general cross-sectional view taken along the line B-B′ of FIG. 3. FIG. 6(a) is a general cross-sectional view taken along the line B-B′ of FIG. 3 showing the state in which the second opening is closed with the cover. FIG. 6(b) is a general cross-sectional view taken along the line B-B′ of FIG. 3 showing the state in which the second opening is opened. Incidentally, in the figure, the ink supply means in the inkjet recording apparatus side is omitted herefrom.

In the figure, reference numeral 103a13 denotes a third engagement rib provided inside the cover 103a5, which has a function that, when the ink supply means (not shown) in the inkjet recording apparatus side is pulled out, engages with an engagement rib 205 (see FIG. 9) provided in the ink feeding tube 203 (see FIG. 9) of the ink supply means to close again the second opening 103a10. Reference numeral 103a11 denotes a fourth engagement rib provided inside the ink feeding tube and engaging with the first engagement rib 103a8 provided in the cover 103a5, and reference numeral 103a12 denotes a fifth engagement rib provided inside the ink feeding tube and engaging with the second engagement rib 103a9 provided in the cover 103a5.

As shown in the figure, the cover 103a5 is designed, before use, to close the second opening 103a10 when the first engagement rib 103a8 and second engagement rib 103a9 which are provided in the cover side engage with the fourth engagement rib 103a11 and fifth engagement rib 103a12 which are provided inside the ink feeding tube. The other reference numerals are the same as those of FIG. 5.

FIG. 7 is an enlarged general view of the positioning control member shown in FIG. 1. FIG. 7(a) is an enlarged general perspective view of the positioning control member shown in FIG. 1. FIG. 7(b) is an enlarged general cross-sectional view showing the state in which the ink feeding section is inserted into the positioning control member shown in FIG. 1.

In the figure, reference numeral 104 denotes the positioning control member. Reference numeral 104a denotes the accommodation section for accommodating the two flange members 103a2 (103a3) of the positioning control means shown in FIG. 4. Reference numeral 104b denotes a cut-off portion for the ink feeding tube 103a1 mounted with the joint member 103a4 of the ink feeding section in accommodating the two flange members 103a2 (103a3) shown in FIG. 4. Reference numeral 104c denotes an insertion port for inserting the ink supply means in the inkjet recording apparatus side into the first opening 103a6 of the ink feeding tube 103a1, the insertion port being provided in the positioning control member so that the center of the insertion port 104c and the center of the first opening 103a6 are identical to each other. In the present invention, a face provided with the insertion port 104c of the positioning control member 104 is referred to as the front face and a face provided with the cut-off portion is referred to as the rear face. Incidentally, the center of the insertion port 104c is provided in the front face so as to be identical to the center of the front face of the positioning control member 104. As shown in FIG. 7(b), when the two flange members 103a2 (103a3) of the positioning control means of the ink feeding section are accommodated in the accommodation section 104a, a position of the ink feeding section is determined and controlled, and then fixed. By accommodating in the outer box in the state as described above, the position of the ink feeding section is controlled by the positioning control member 104, and when the perforated line provided in the open-close cover of the outer box is cut off, the first opening 103a6 of the ink feeding tube 103a1 protrudes, thereby the insertion of the ink supply means in the inkjet recording apparatus side into the first opening 103a6 can be easily carried out without fail.

Although the material used for the positioning control member is not specifically limited, it is preferable to unify the material as a whole considering the disposal of the ink cartridge after use. For example, the same resin material as that of the ink feeding section of the ink pack may be used to produce the positioning control member by the injection molding method. When the outer box is made of a paper material, the same paper or so called a molded pulp product in which paper materials are used may be possible. In the case of the molded pulp product, materials to be used are not limited, and for example, non-wood pulps of perennial plants such as a reed, newspapers, cardboards, used papers and the like may be used. Further, as the production method, it may be possible to produce the positioning control member by the common method of melting materials followed by molding with a molding machine.

FIG. 8 is an enlarged general cross-sectional view taken along the line A-A′ of the ink cartridge shown in FIG. 1.

The first protective member 102a has a first protective section 102a1, a second protective section 102a2 and a third protective section 102a3. The first protective section 102a1 has a face 102a11 (wherein referred to as an X face) contacting a rear face of the positioning control member 104, a face 102a12 (wherein referred to as a Y face) contacting the first face 101f1 (see FIG. 2) inside a face containing the long side of the opening 101d (see FIG. 2) of the main body 101c, and an inclined face 102a13 (wherein referred to as a Z face) contacting the a-face 103b1 containing the short side of the ink accommodation section, the cross-section thereof having a triangle form. The second protective section 102a2 has a face 102a21 (wherein referred to as an X face) contacting the inner face 101h1 (see FIG. 2) of an opposed face of the main body 101c opposite to the opening 101d (see FIG. 2), a face 102a22 (wherein referred to as a Y face) contacting the first face 101f1 (see FIG. 2) inside the face containing the long side of the opening 101d (see FIG. 2) of the main body 101c, and an inclined face 102a23 (wherein referred to as a Z face) contacting the a-face 103b1 containing the short side of the ink accommodation section 103b, the cross-section thereof having a triangle form. The third protective section 102a3 is a flat member monolithically formed by the face 102a12 of the first protective section 102a1 and the face 102a22 of the second protective section 102a2.

The second protective member 102b has a first protective section 102b1, a second protective section 102b2, and a third protective section 102b3. The first protective section 102b1 has a face 102b11 (wherein referred to as an X face) contacting a rear face of the positioning control member 104, a face 102b12 (wherein referred to as a Y face) contacting the first face 101f1 (see FIG. 2) inside the face containing the long side of the opening 101d (see FIG. 2) of the main body 101c, and an inclined face 102b13 (wherein referred to as a Z face) contacting the a-face 103b1 containing the short side of the ink accommodation section, the cross-section thereof having a triangle form. The second protective section 102b2 has a face 102b21 (wherein referred to as an X face) contacting the inner face 101h1 (see FIG. 2) of the opposed face of the main body 101c opposite to the opening 101d (see FIG. 2), a face 102b22 (wherein referred to as a Y face) contacting the first face 101f1 (see FIG. 2) inside the face containing the long side of the opening 101d (see FIG. 2) of the main body 101c, and an inclined face 102b23 (wherein referred to as a Z face) contacting the a-face 103b1 containing the short side of the ink accommodation section 103b, the cross-section thereof having a triangle form. The third protective section 102b3 is a flat member monolithically formed by the face 102b12 of the first protective section 102b1 and the face 102b22 of the second protective section 102b2.

The first protective member 102a and the second protective member 102b have the same embodiment. In this figure, although the first protective section 102a1 and second protective section 102a2 of the first protective member 102a are monolithically integrated via the flat member 102a3, they may be independent from each other. Similarly, although the first protective section 102b1 and second protective section 102b2 of the second protective member 102b are monolithically integrated via the flat member 102b3, they may be independent from each other.

θ1 indicates an angle made by the face 102b21 (102a21) (X face) and the inclined face 102b23 (102a23) (Z face), θ2 indicates an angle made by the face 102b22 (102a22) (Y face) and the inclined face 102b23 (102a23) (Z face). θ3 indicates an angle made by the face 102b11 (102a11) (X face) and the inclined face 102b13 (102a13) (Z face), and θ4 indicates an angle made by the face 102b12 (102a12) (Y face) and the inclined face 102b13 (102a13) (Z face).

The angle θ1 (θ3) is preferably 68 through 84°. When the angle θ1 (θ3) is less than 68°, the outer box becomes larger and may not be inserted into the ink cartridge insertion section in the inkjet recording apparatus side. When the angle θ1 (θ3) is more than 84°, the ink accommodation section is in the state of being pressed by a buffer member, so that when the ink inside the ink accommodation section is reduced, wrinkles occur in the ink accommodation section by the buffer member, and the ink remains in the wrinkles, thereby the remaining amount of the ink may increase.

The angle θ2 (θ4) is preferably 7 through 22°. When the angle θ2 (θ4) is less than 7°, the ink accommodation section is in the state of being pressed by the buffer member, so that when the ink inside the ink accommodation section is reduced, wrinkles occur in the ink accommodation section by the buffer member, and the ink remains in the wrinkles, thereby the remaining amount of the ink may increase.

When the angle θ2 (θ4) is more than 22°, the outer box becomes larger and may not be inserted into the ink cartridge insertion section in the inkjet recording apparatus side.

In the figure, Q indicates a height from the second face 101g1 of the main body 101c to the half of the inner face 101h1, and P indicates a height of the face 102b21 (X face) of the second protective section 102b2. The height P is preferably 23 through 91% relative to the height Q. When the height is less than 23%, the ink accommodation section is in the state of being pressed by the buffer member, so that when the ink inside the ink accommodation section is reduced, wrinkles occur in the ink accommodation section by the buffer member, and the ink remains in the wrinkles, thereby the remaining amount of ink may increase. When the height is more than 91%, the ink feeding tube may be restricted in thickness, and the ink accommodation section has less impact resistance capability due to little allowance within the outer box caused by being pressed by the buffer member and is in danger of exploding when falling down.

The heights of the face 102a11 of the first protective section 102a1 and the face 102a21 of the second protective section 102a in the first protective member 102a as well as the face 102b11 of the first protective section 102b1 in the second protective member 102b have the same relationship as the height of the face 102b21 of the second protective section 102b2 in the second protective member 102b.

The figure shows the case in which the a-face 103b1 of the ink accommodation section is fixed in the inner face 101f1 of the main body 101c in the outer box with a double-stick tape 103c. The ink cartridge shown in the figure is preferably loaded in the inkjet recording apparatus side in the state where the ink feeding section is erected downward, and when it is used in this state, the remaining amount of the ink may be minimized.

When the ink cartridge shown in the figure is used in the state shown in the figure, it is preferably used by the method described in Japanese Patent Publication Laid-Open No. 2003-145785. When the ink cartridge is used in the state of being horizontal, it is preferably used by the method described in Japanese Patent Publication Laid-Open No. 2003-226023. By using the cartridge of the present invention shown in FIGS. 1 through 8, the following advantages will be achieved.

1) Since the ink pack was restricted in movement inside the ink cartridge by the protective members, the resistance capability against transportation, vibration during operation, falling and the like was improved, so that the ink accommodation section may be prevented from being damaged, thereby safety transportation and operation could be realized.

2) Since the ink feeding section was inserted into the positioning control member and restricted in its position, loading to the ink supply section in the inkjet recording apparatus side could be easily carried out.

3) When the ink cartridge was loaded to the ink supply section in the inkjet recording apparatus side and used in the state of being erected, the inclined face of the protective member in the ink feeding section side acted as a funnel function, so that the remaining amount of the ink inside the ink accommodation section could be reduced.

4) When the ink cartridge was loaded to the ink supply section in the inkjet recording apparatus side and used in the sate of being erected, since one side of the ink accommodation section was fixed in the inner face of the main body in the outer box, the ink accommodation section fell down in the ink feeding section side without being deformed even though the remaining amount of the ink inside the ink accommodation section decreased, so that the ink could be used up and the reduction of the ink residue could be achieved.

5) The members composing the ink cartridge were disassemblable, so that separated collection of the waste after use was facilitated and the recycling capability improved.

FIG. 9 is a general view of the insertion member which is the ink supply means in the inkjet recording apparatus side. FIG. 9(a) is a general perspective view of the insertion member which is the ink supply means in the inkjet recording apparatus side. FIG. 9(b) is a general cross-sectional view taken along the line C-C′ of FIG. 9(a).

In the figure, reference numeral 2 denotes an insertion member which is the ink supply means in the inkjet recording apparatus side and is inserted into the first opening 103a6 (see FIG. 4) of the ink feeding tube 103a1 (see FIG. 4). The insertion member 2 has, when inserted into the first opening 103a6 (see FIG. 4), an end portion 201 abutting an inside end of the cover 103a5 (see FIG. 4) of the ink feeding tube 103a1 (see FIG. 4) and releasing the cover 103a5 (see FIG. 4) from the engagement with the ink feeding tube 103a1 (see FIG. 4) due to the pressure to open the second opening 103a9 (see FIG. 5); an ink supply section 202; a hollow cylindrical ink supply tube 203; and an ink leakage prevention member 204 for preventing the leakage of ink.

Reference numeral 202a denotes an ink supply port provided in the ink supply section 202. The ink supply section 202 is provided with at least one ink supply port 202a which is not specifically limited in form, and the form may be, for example, rectangular, square, circular, or oval. The area of the ink supply port is 1 through 20 mm². Incidentally, a plurality of ink supply ports may be possible with the area in the range of 1 though 20 mm². The number of the supply ports may be suitably provided in the range that, for example, one is for 1 mm² of the area of the ink supply port, 1 through 20 for 20 mm² thereof according to the necessity.

When the area of the ink supply port is less than 1 mm², the amount of the ink supply to the inkjet recording apparatus is insufficient, and even though the ink is present in the ink cartridge, a detection device of the inkjet recording apparatus improperly operates to issue a warning that the ink cartridge is empty, and also stable images cannot be obtained, which is not preferred. When the area of the ink support port is more than 20 mm², the strength of the ink supply tube is insufficient and the durability disappears, which is not preferred.

R indicates an inner diameter of the ink supply tube 203. The inner diameter R is 4 through 8 mm. When the inner diameter R is less than 4 mm, the amount of the ink supply to the inkjet recording apparatus is insufficient, so that even though the ink is present in the ink cartridge, the detection device of the inkjet recording apparatus improperly operates to issue a warning that the ink cartridge is empty and stable images cannot be obtained, which is not preferred. When the inner diameter R is more than 8 mm, the ink feeding tube of the ink feeding section of the ink cartridge becomes large with the whole ink cartridge growing, the ink supply section in the inkjet recording apparatus side becomes so large that the cost would increase, which is not preferred.

Reference numeral 205 denotes an engagement rib which has a function that, when the insertion member 2 is pulled out, engages with the third engagement rib 103a13 (see FIG. 6) provided inside the cover 103a5 (see FIG. 6) of the ink feeding tube 103a1 (see FIG. 6) to close again the second opening 103a9 (see FIG. 6) of the ink feeding tube 103a1 (see FIG. 6) with the cover 103a5 (see FIG. 6). Reference numeral 206 denotes a joint section to the ink supply tube in the inkjet recording apparatus side. The ink supplied from the ink supply section 202 of the insertion member 2 is supplied to the inkjet head of the inkjet recording apparatus via the ink supply tube 203.

Although the material used for the insertion member 2 is not specifically limited, from the standpoint of the cost and easiness of production, the thermoplastic resin is the most preferable one. As the production method, it may be possible to produce the insertion member by the common method of injection molding as described in “Jitsuyou Plastic Seikei Kako Binran (Practical Plastic Molding Handbook)” edited by All Japan Plastic Products Industrial Federation. Although the thermoplastic resin to be used is not specifically limited as long as injection molding can be carried out, for example, common resins such as polyethylene, polystyrene, polyamide, polyacetal, polycarbonate, and polypropylene may be used.

FIG. 10 is a general flow chart of the ink supply from the ink pack to the inkjet through the ink supply tube which is the ink supply means in the inkjet recording apparatus side. Incidentally, the figure shows the case in which the ink feeding section of the ink cartridge shown in FIGS. 1 through 8 is used being erected downward. Further, the outer box and the poisoning control member that compose the ink cartridge are omitted herefrom.

In S1, the position of the first opening 103a6 of the ink feeding section 103a of the ink cartridge and the position of the insertion member 2 which is the ink supply means in the inkjet recording apparatus side are fitted, and then the first opening 103a6 is moved downward (the ink cartridge is moved downward) (the arrow direction in the figure) in order to insert the insertion member 2 into the first opening 103a6.

In S2, the end portion 201 of the insertion member 2 is inserted into a position abutting the end of the inner face of the cover 103a5. In this stage, the cover 103a5 is in the state of being engaged inside the ink feeding tube 103a1 and closing the second opening of the ink feeding tube 103a1.

In S3, when the first opening 103a6 is further moved downward (the ink cartridge is moved downward) (the arrow direction in the figure), the engagement of the cover 103a5 with the ink feeding tube 103a1 is in the state of being released and the second opening 103a10 is opened. In this state, the ink supply section 202 having at least one ink supply port 202a of the insertion member 2 is to be placed between the second opening 103a10 and the cover 103a5. The ink filled in the ink accommodation section 103 is to be supplied to the inkjet via the hollow cylindrical ink supply tube 203 from the ink supply port 202a.

When printing is finished, the ink cartridge is moved upward and the insertion member 2 is pulled out from the ink feeding section, so that the third engagement rib 103a13 provided inside within the cover 103a5 and the engagement rib 205 provided in the ink supply tube 2 engage with each other to close the second opening 103a10. Incidentally, the figure shows the case in which the insertion member of the ink supply means is inserted into the opening of the ink feeding section of the ink cartridge by fixing the ink supply means of the inkjet recording apparatus to cause the ink cartridge to move, however, the insertion member may also be inserted by fixing the ink cartridge in the loading section of the inkjet recording apparatus to cause the insertion member of the ink supply means to move. In this case, the insertion member is preferably cleaned by a cleaning means when inserted and pulled out. The cleaning means may be provided, for example, by the method of wiping with a sponge or polymer absorbent.

By using the ink supply means in the inkjet recording apparatus side as shown in FIG. 9, FIG. 10 and the ink cartridge as shown in FIGS. 1 through 8, the following effects were achieved.

1. As shown in S1 through S3, the putting on and taking out of the ink cartridge toward the ink supply mean s in the inkjet recording apparatus side could easily be carried out, so that the replacement of the ink cartridge was facilitated.

2. Since the ink pack could be closed after use, the ink inside the ink pack could be prevented from deterioration and stored. Further the ink could be used up because deterioration was prevented, so that the cost suppression could be achieved by eliminating the waste.

Effects of the present invention will be specifically described with reference to examples. However, the present invention is not to be construed as limited to these examples.

### EXAMPLES

Ink cartridges were produced using the materials listed below.

(Production of Ink Feeding Sections)

Using HDPE as the thermoplastic resin, ink feeding sections shown in FIG. 4 were produced by injection molding. Incidentally, the size of the first opening of the ink feeding tube of the ink feeding section was set depending on the size of the ink supply tube. The diameter of the flange member mounted in the ink feeding tube was set to 20 mm, the thickness to 1 mm, and the spacing between the two flange members to 2 mm.

(Production of Ink Packs)

Using PET 12 μm/aluminum foil 12 μm/ONy 15 μm/LLDPE 20 μm/black LLDPE 50 μm as the multilayer thermoplastic film, cylindrical forms were made by the center seal system, each inserted with the joint member of the produced ink feeding section, and then jointed by thermal welding respectively. Incidentally, the black LLDPE used in the sealant layer was that prepared by adding carbon black into LLDPE produced using a metallocene catalyst. Subsequently, for each of the cylindrical forms made as described above, the UV curing ink with the viscosity varied as shown in Table 1 was filled under reduced pressure and either of the openings was sealed by thermal welding to produce the ink pack of the embodiment shown in FIG. 3. The produced ink packs were represented as A through E.

The UV curing ink used herein was that having the composition as listed below, and the viscosity was adjusted by adding a solvent. The viscosity measurement shows the value measured with the Reometer MCR 300 manufactured by Physica Co., Ltd.

Each of the UV curing ink components listed blow was mixed together and stirred, and then the resulting solution was filtered with a filter to obtain the UV curing ink.

Carbon black MA 100 (pigment for black ink, manufactured by Mitsubishi Chemical Co., Ltd.) 5% by mass

Alicyclic epoxy compound (CEL2021P, manufactured by Daicel Chemical Industries Ltd.) 40% by mass

Oxetane (OXT221, manufactured by Toagosei Co., Ltd.) 70% by mass

Light polymerization initiator: sulfonium salt (SP152, manufactured by Asahi Denka Co., Ltd.) 2.5% by mass

Anthracen derivative (CS7102, manufactured by Nippon Soda Co., Ltd.) 1.0% by mass

The size of the ink accommodation section of the ink packs produced above was set the length of the short side to 230 mm, the length of the long side to 450 mm, and the volume to 3 L. The rigidity of the multilayer thermoplastic film used herein was 1.3×10⁻⁶ Nm². Incidentally, the value of the rigidity was measured using the tension tester PSC-100 manufactured by Shimazu Corporation.

TABLE 1

| Ink Pack No. | Viscosity (Pa · s) | Remarks |
|---|---|---|
| A | 0.004 | Comparison |
| B | 0.005 | Invention |
| C | 0.01 | Invention |
| D | 0.05 | Invention |
| E | 0.1 | Invention |
| F | 0.15 | Comparison |

(Production of Outer Boxes)

Using paperboard with the basic weight of 450 g/m² and the thickness of 590 μm, boxes having the form shown in the exploded view of FIG. 2 were produced. The size of the opening was set to 225 mm width and 70 mm height.

(Production of Positioning Control Members)

Using cardboard as the material, positioning control members as shown in FIG. 7 were produced by pulp molding. The size of the accommodation section of the positioning control member was set to the size in which the two flange members mounted in the ink feeding section could be accommodated, and the cut-off section the ink feeding tube entering was set depending on the diameter of the ink feeding tube. The width and height of the positioning control member were set depending on the size of the opening of the outer box.

(Production of Protective Members)

Using the same paperboard as that of the outer box, first protective members and second protective members shown in FIG. 1 were produced by setting the height of the X face to 20 mm, the angle made by the X face and the Z face to 72°, and the angle made by the Y face and the Z face to 18°. The first protective member and the second protective member were designed to have the same form. Incidentally, the X face indicates a face contacting the rear face of the positioning control member (a face contacting the inner face of the opposed face of the main body opposite to the opening), the Y face indicates a face contacting the first face (the second face) inside the face containing the long side of the opening of the main body, and the Z face indicates an inclined face contacting the a-face (b-face) containing the short side of the ink accommodation section. The height of the X face indicates, as shown in FIG. 8, the percentage (%) of the height of the X face of the buffer member relative to the height to the half of the inner face from the second face of the main body in the outer box (35 mm).

(Production of Ink Cartridges)

The ink feeding sections of the ink packs A through F produced as described above were accommodated in the accommodation sections of the positioning control members, and using the produced protected members, being accommodated in the produced outer boxes in the state as shown in FIG. 8 to produce ink cartridges shown in Table 2.

TABLE 2

| Ink Cartridge | Ink Pack | |
|---|---|---|
| No. | No. | Remarks |
| 1-1 | A | Comparison |
| 1-2 | B | Invention |
| 1-3 | C | Invention |
| 1-4 | D | Invention |
| 1-5 | E | Invention |
| 1-6 | F | Comparison |

(Production of Ink Supply Tubes)

Using HDPE as the thermoplastic resin, ink supply tubes which are the ink supply means in the inkjet recording apparatus shown in FIG. 9 were produced by varying, as shown in Table 3, the area and inner diameter of the ink supply tube by injection molding. The produced ink supply tubes were represented by a through 1. Incidentally, the ink supply tube was provided with four ink supply ports each having a rectangular form and the same area.

TABLE 3

| | | Inner diameter | |
|---|---|---|---|
| | Area of ink | of ink supply | |
| Ink supply | supply port | tube | |
| tube No. | (mm²) | (mm) | Remarks |
| a | 0.8 | 6 | Comparison |
| b | 1 | 6 | Invention |
| c | 5 | 6 | Invention |
| d | 10 | 6 | Invention |
| e | 15 | 6 | Invention |
| f | 20 | 6 | Invention |
| g | 21 | 6 | Comparison |
| h | 18 | 3 | Comparison |
| i | 18 | 4 | Invention |
| j | 18 | 6 | Invention |
| k | 18 | 8 | Invention |
| l | 18 | 9 | Comparison |

(Production of Sample Materials)

The ink supply section of the inkjet recording apparatus LF-900 manufactured by Konica Co., Ltd. was modified and mounted with the produced ink supply tubes a through 1, being loaded with the produced ink cartridges 1-1 through 1-6, and by which the print-record was carried out on 20 sheets of polyethylene terephthalate films in A2 size as the recording media to produce printed materials which were represented by sample materials 101 through 173. The printing speed was 20 min/sheet.

(Evaluation)

For each of the printed materials 101 through 173 produced as described above, the printing quality was visually checked, and the evaluation was made in accordance with the evaluation rank described blow. The results are shown in Table 4 and Table 5.

Evaluation rank

B: Images created without defects
C: A few defects allowable for the products
D: Appropriate images are not created unless the
printing speed is reduced.

TABLE 4

| Sample | Ink | Ink | | |
|---|---|---|---|---|
| material | cartridge | supply | Printing | |
| No. | No. | tube No. | quality | Remarks |
| 101 | 1-1 | a | D | Comparison |
| 102 | 1-1 | b | D | Comparison |
| 103 | 1-1 | c | D | Comparison |
| 104 | 1-1 | d | D | Comparison |
| 105 | 1-1 | e | D | Comparison |
| 106 | 1-1 | f | D | Comparison |
| 107 | 1-1 | g | D | Comparison |
| 108 | 1-1 | h | D | Comparison |
| 109 | 1-1 | i | D | Comparison |
| 110 | 1-1 | j | D | Comparison |
| 111 | 1-1 | k | D | Comparison |
| 112 | 1-1 | l | D | Comparison |
| 113 | 1-2 | a | B | Comparison |
| 114 | 1-2 | b | B | Invention |
| 115 | 1-2 | c | B | Invention |
| 116 | 1-2 | d | B | Invention |
| 117 | 1-2 | e | B | Invention |
| 118 | 1-2 | f | B | Invention |
| 119 | 1-2 | g | B | Comparison |
| 120 | 1-2 | h | B | Comparison |
| 121 | 1-2 | i | B | Invention |
| 122 | 1-2 | j | B | Invention |
| 123 | 1-2 | k | B | Invention |
| 124 | 1-2 | l | B | Comparison |
| 125 | 1-3 | a | B | Comparison |
| 126 | 1-3 | b | B | Invention |
| 128 | 1-3 | c | B | Invention |
| 129 | 1-3 | d | B | Invention |
| 130 | 1-3 | e | B | Invention |
| 131 | 1-3 | f | B | Invention |
| 132 | 1-3 | g | B | Comparison |
| 133 | 1-3 | h | B | Comparison |
| 134 | 1-3 | i | B | Invention |
| 135 | 1-3 | j | B | Invention |
| 136 | 1-3 | k | B | Invention |
| 137 | 1-3 | l | B | Comparison |

TABLE 5

| Sample | Ink | Ink | | |
|---|---|---|---|---|
| material | cartridge | supply | Printing | |
| No. | No. | tube No. | quality | Remarks |
| 138 | 1-4 | a | B | Comparison |
| 139 | 1-4 | b | B | Invention |
| 140 | 1-4 | c | B | Invention |
| 141 | 1-4 | d | B | Invention |
| 142 | 1-4 | e | B | Invention |
| 143 | 1-4 | f | B | Invention |
| 144 | 1-4 | g | B | Comparison |
| 145 | 1-4 | h | B | Comparison |
| 146 | 1-4 | i | B | Invention |
| 147 | 1-4 | j | B | Invention |
| 148 | 1-4 | k | B | Invention |
| 149 | 1-4 | l | B | Comparison |
| 150 | 1-5 | a | B | Comparison |
| 151 | 1-5 | b | B | Invention |
| 152 | 1-5 | c | B | Invention |
| 153 | 1-5 | d | B | Invention |
| 154 | 1-5 | e | B | Invention |
| 155 | 1-5 | f | B | Invention |
| 156 | 1-5 | g | B | Comparison |
| 157 | 1-5 | h | B | Comparison |
| 158 | 1-5 | i | B | Invention |
| 159 | 1-5 | j | B | Invention |
| 160 | 1-5 | k | B | Invention |
| 161 | 1-5 | l | B | Comparison |
| 162 | 1-6 | a | D | Comparison |
| 163 | 1-6 | b | D | Comparison |
| 164 | 1-6 | c | D | Comparison |
| 165 | 1-6 | d | D | Comparison |
| 166 | 1-6 | e | D | Comparison |
| 167 | 1-6 | f | D | Comparison |
| 168 | 1-6 | g | D | Comparison |
| 169 | 1-6 | h | D | Comparison |
| 170 | 1-6 | i | D | Comparison |
| 171 | 1-6 | j | D | Comparison |
| 172 | 1-6 | k | D | Comparison |
| 173 | 1-6 | l | D | Comparison |

According to the results shown in Table 4 and Table 5, in the case of the sample material Nos. 101 through 112, as the area of the ink supply port of the ink supply tube was small, the amount of ink supply per unit time was insufficient and there was a lot of defects at the printing speed of 20 min/sheet, so that the printing speed needed to be reduced to 40 min/sheet, resulting in lesser production capability. In the case of the sample material Nos. 162 through 173, as the ink viscosity was high, liquid droplets from the inkjet head could not be formed, thereby it was difficult to form images. The sample material Nos. 113, 120, 125, 133, 138, 145, 150, and 157 had no problem in the printing quality, however, the ink detection device of the inkjet recording apparatus operated improperly (displayed the ink running out) and the printing job was interrupted, resulting in lesser production capability. The sample material Nos. 119, 132, 144, 156 had no problem in the printing quality, however, the strength of the ink supply tube was insufficient for repeated use and it was judged to be difficult to realize practical application. In the case of the sample material Nos. 124, 137, 149, 161, 173, as the ink feeding tube of the ink feeding section of the ink cartridge became large with the whole ink cartridge growing, and the ink supply section in the inkjet recording apparatus side became so large that the cost would increase, thereby it was judged to be difficult to realize practical application. The effectiveness of the present invention was confirmed.

### Example 2

After the production of the printing sample material Nos. 138 through 149, the used ink cartridges 1 through 4 were kept at 70° C. for seven days, which were represented by sample materials 201 and 212. After the keeping, the viscosity of the ink remaining in each of the sample materials 201 through 212 was measured again. The results are shown in Table 6. Incidentally, the viscosity measurement was carried out with the Reometer MCR300 manufactured by Physica Co., Ltd.

TABLE 6

| | Example 1, | Ink viscosity | Ink viscosity |
|---|---|---|---|
| Sample material | Sample | before use | after keeping |
| No. | material No. | (Pa · s) | (Pa · s) |
| 201 | 138 | 0.05 | 0.05 |
| 202 | 139 | 0.05 | 0.05 |
| 203 | 140 | 0.05 | 0.05 |
| 204 | 141 | 0.05 | 0.05 |
| 205 | 142 | 0.05 | 0.05 |
| 206 | 143 | 0.05 | 0.05 |
| 207 | 144 | 0.05 | 0.05 |
| 208 | 145 | 0.05 | 0.05 |
| 209 | 146 | 0.05 | 0.05 |
| 210 | 147 | 0.05 | 0.05 |
| 211 | 148 | 0.05 | 0.05 |
| 212 | 149 | 0.05 | 0.05 |

It was possible to constantly obtain images using an ink cartridge easily replaced toward the inkjet recording apparatus, capable of being reused by preventing deterioration of the ink in the ink cartridge after use, and enabling the constant supply of the required amount of ink to the inkjet head even using the ink having a high viscosity; an inkjet recording apparatus having an ink supply means; a method of supplying ink to the inkjet recording apparatus; and an UV curing ink having a high viscosity. In addition, because the reuse was possible, the waste of ink was eliminated and the cost could be suppressed.

What is claimed is:

1. An ink cartridge for inkjet recording apparatus comprising:
an ink pack including an ink feeding section of thermoplastic resin; a bag-like ink accommodation section of multilayer thermoplastic film materials; an ink filled in said ink pack; a positioning control member for controlling a position of said ink feeding section; and an outer box for accommodating said ink pack,
wherein said ink feeding section comprises a hollow cylindrical ink feeding tube including: a joint section for jointing with said ink accommodation section; a positioning control means accommodated in said positioning control member; a first opening through which an ink supply means in said inkjet recording apparatus can be inserted and pulled out; a second opening for supplying said ink to said inkjet recording apparatus from said ink accommodation section via said first opening; and a cover for opening said second opening by inserting said ink supply means and for closing said second opening by pulling out said ink supply means, and wherein said ink is the UV curing type with a viscosity of 0.005 through 0.1 Pa·s.

2. The ink cartridge for inkjet recording apparatus of claim 1, wherein inside of said cover of ink cartridge for inkjet recording apparatus comprises an engagement section capable of engaging with and disengaging from said ink supply means.

3. The ink cartridge for inkjet recording apparatus of claim 1, wherein said ink pack is protected by protective members.

4. An inkjet recording apparatus comprising: an ink supply means including an insertion member capable of being inserted and pulled out through said first opening in the ink cartridge for inkjet recording apparatus of claim 1, wherein said insertion member comprises a hollow cylindrical ink supply tube including at an end portion thereof an engagement section for opening and closing said cover, an ink supply port, and an ink leakage prevention member, and wherein said ink is the UV curing type with a viscosity of 0.005 through 0.1 Pa·s; an area of said ink supply port being 1 through 20 mm²; an inner diameter of said ink supply tube being 4 through 8 mm.

5. The inkjet recording apparatus of claim 4, wherein said insertion member comprises a cleaning member for cleaning said insertion member.

6. The inkjet recording apparatus of claim 4, wherein said ink pack is protected by protective members.

7. A method of supplying ink to the inkjet recording apparatus by inserting the insertion member in the ink supply means into said ink feeding section from the ink cartridge for inkjet recoding apparatus of claim 1, wherein said insertion member comprises a hollow cylindrical ink supply tube including at an end portion thereof an engagement section for opening and closing the cover, an ink supply hole, and an ink leakage prevention member; and wherein said ink is the UV curing type with a viscosity of 0.005 through 0.1 Pa·s; the area of said ink supply port being 1 through 20 mm²; the inner diameter of said ink supply tube being 4 through 8 mm.

8. The method of supplying ink of claim 7, wherein said insertion member can be inserted and pulled-out through the first opening via the cleaning means.

9. The method of supplying ink of claim 7, wherein said ink pack is protected by the protecting members.
